(19) United States
(12) Patent Application Publication
(10) Pub. No.: US 2026/0235796 A1
(43) Pub. Date: Aug. 13, 2026

(54) PROTECTIVE EYEWEAR LENSES WITH MINIMAL COLOR DISTORTION

(71) Applicant: Kentek Corporation, Boscaven, NH (US)

(72) Inventors: Donald Lee Tibbitts, JR., Boscaven, NH (US); Bonnie G. Simmons, Boscaven, NH (US)

(21) Appl. No.: 19/533,550

(22) Filed: Feb. 9, 2026

Related U.S. Application Data
(60) Provisional application No. 63/756,623, filed on Feb. 10, 2025.

(51) Int. Cl. G02B 5/22; G02B 1/04

(52) U.S. Cl. CPC G02B 5/223; G02B 1/041

(57) ABSTRACT

A protective lens includes one or more base materials, one or more absorbing dyes, and one or more color correcting dyes. The lens has a neutrality value that reflects minimal color distortion. The lens may be configured to attenuate selected ultraviolet, visible, and infrared wavelengths, including laser wavelengths, while maintaining low color distortion across a visible spectrum. In some embodiments, the lens exhibits optical density values sufficient to provide laser protection at one or more wavelengths, a photopic luminous transmission value within a selected range, and impact resistance corresponding to a V50 value greater than 800 ft/s. In some embodiments, the lens is configured as a sunglass lens while maintaining a neutrality value of less than 12%.

### CROSS-REFERENCE TO RELATED APPLICATIONS

This application claims priority to and the benefit of U.S. Patent Application No. 63/756,623, filed Feb. 10, 2025, and entitled Protective Eyewear Lenses with Minimal Color Distortion, the entire content of which is incorporated herein by reference.

### BACKGROUND

### 1. Technical Field

The present application relates to eyewear. More specifically, the present application relates to eyewear lenses that can provide one or more types of optical and/or physical protection while limiting color distortions.

### 2. The Relevant Technology

In recent decades, the use of lasers and other sources of high-energy electromagnetic radiation has expanded across numerous technical fields and applications. By way of example, lasers are commonly employed in military and defense systems, industrial manufacturing and materials processing, optical communications, medical procedures, scientific instrumentation, and consumer and commercial devices. In many such applications, personnel may be exposed to potentially harmful radiation and are therefore required to wear protective eyewear lenses designed to attenuate selected wavelengths of light.

Protective eyewear lenses have also been developed to provide protection from ultraviolet (UV) and visible spectrum (VIS) radiation, as well as from infrared (IR) radiation associated with laser sources. In addition, protective eyewear lenses may be required to meet impact or ballistic performance requirements, such as those applicable to military, law-enforcement, or industrial safety eyewear. These various protective requirements often impose material, thickness, and optical constraints on the lens.

Conventional protective eyewear lenses capable of providing high levels of laser attenuation, UV and IR blocking, and/or ballistic resistance commonly rely on absorbing dyes, pigments, or additives incorporated into polymeric lens materials, such as polycarbonate. While effective at providing protection, such approaches frequently result in significant color distortion across the visible spectrum. For example, lenses designed to attenuate multiple laser or IR wavelengths often exhibit brown, green, or otherwise highly tinted appearances that alter the perceived colors of a wearer's surroundings.

Color distortion may adversely affect situational awareness, visual acuity, and the ability to accurately perceive environmental details, particularly in applications where color recognition is important. The problem of color distortion is further exacerbated when high optical density requirements are combined with ballistic-grade materials and thicknesses, as the cumulative optical effects of the material and absorbing components can introduce non-uniform attenuation across the visible spectrum.

Although various protective eyewear solutions exist, they typically involve tradeoffs between protection level, light transmission, impact resistance, and visual fidelity. As a result, there remains a need for protective eyewear lenses capable of providing robust optical and physical protection while limiting color distortion and preserving a more neutral visual appearance.

### BRIEF SUMMARY

The present application relates to protective eyewear lenses. More specifically, the present application relates to eyewear lenses that can provide one or more types of optical and/or physical protection while limiting color distortions.

In one example embodiment, a protective eyewear lens, including: one or more base materials; one or more absorbing dyes; and one or more color-correcting dyes, wherein the lens is configured to: attenuate electromagnetic radiation in at least one ultraviolet wavelength range and at least one infrared wavelength range; and exhibit a neutrality value of less than 12%, wherein the color-correcting dyes reduce non-uniform attenuation across a visible spectrum without materially degrading protective performance of the lens.

In one example embodiment, a protective eyewear lens configured as a sunglass lens, including: a ballistic-grade polymer base material; one or more absorbing dyes configured to attenuate ultraviolet and infrared radiation; and one or more color-correcting dyes, wherein the lens: has a photopic luminous transmission value of less than 20%; attenuates at least one laser wavelength; and exhibits a neutrality value of less than 12%.

In one example embodiment, a protective eyewear lens, including: one or more base materials; one or more absorbing dyes; and one or more color-correcting dyes, wherein the lens has: optical density values of at least OD4 in a wavelength range from about 180 nm to about 300 nm, at least OD7 at about 1064 nm, and at least OD4 in a wavelength range from about 820 nm to about 870 nm; a photopic luminous transmission value between about 18% and about 40%; an impact rating corresponding to a V50 value greater than 800 ft/s; and a neutrality value of less than 12%.

In one example embodiment, a protective lens includes: one or more base materials; one or more absorbing dyes; and one or more color correcting dyes, wherein the lens has the following properties: optical density values of: OD4+@180-300 nm, OD7+@1064 nm, and OD4+820-870 nm; a PLT value of 18% to 40%; an impact rating of V50 greater than 800 ft/s; and a neutrality value of less than 12%.

In one example embodiment, a protective lens includes: one or more base materials; one or more absorbing dyes; and one or more color correcting dyes, wherein the lens has a neutrality value of less than 12% and one or more of the following properties: optical density values of: OD4+@180-300 nm, OD7+@ 1064 nm, and OD4+820-870 nm; a PLT value of 18% to 40%; and/or an impact rating of V50 greater than 800 ft/s.

These and other objects and features of the present invention will become more fully apparent from the following description and appended claims, or may be learned by the practice of the invention as set forth hereinafter.

### BRIEF DESCRIPTION OF THE DRAWINGS

To further clarify the above and other advantages and features of the present disclosure, a more particular description will be rendered by reference to specific embodiments thereof which are illustrated in the appended drawings. It is appreciated that these drawings depict only illustrated embodiments of the disclosure and are therefore not to be considered limiting of its scope. The disclosure will be described and explained with additional specificity and detail through the use of the accompanying drawings in which:

FIG. 1 is a graphical representation of impact or ballistic performance for an example protective eyewear lens, illustrating an achieved V50 impact rating.

FIG. 2 is a graphical representation of optical density as a function of wavelength for an example protective eyewear lens.

FIG. 3 is a graphical representation of transmission as a function of wavelength for an example protective eyewear lens.

FIG. 4 is a chromaticity plot illustrating color characteristics of an example protective eyewear lens relative to a chromaticity coordinate system.

FIG. 5 illustrates an example dye formulation corresponding to a representative spectral profile of a protective eyewear lens.

### DETAILED DESCRIPTION

The present application relates to protective eyewear lenses. More specifically, the present application relates to protective eyewear lenses that can provide one or more types of protection while limiting color distortion.

Protective eyewear lenses of the present disclosure may provide protection from infrared wavelengths of light (e.g., lasers), ultra-violet (UV) and/or visible spectrum (VIS) wavelengths of light, and/or impact (e.g., ballistic). Such protective eyewear lenses may be configured to attenuate selected wavelengths of electromagnetic radiation while maintaining low color distortion across the visible spectrum. Each of these protection features will be discussed in greater detail below. In addition to providing one or more of the noted protection features, the protective eyewear lenses of the present disclosure may also limit, minimize, or counteract the color distortion resulting from one or more of the noted protective features.

When creating a protective eyewear lens according to the present disclosure, one may begin by defining the desired levels of protection. The desired levels of protection may be application-specific and may be selected based on intended use environments, including military, industrial, recreational, or consumer eyewear applications. The desired levels of protection may include impact resistance and/or the electromagnetic wavelengths to be blocked/attenuated. Once these levels are defined, the Beer-Lambert law may be used, at least as a starting point, to design the protective eyewear lenses. Beer-Lamberts law relates to the attenuation of light (radiation) by the absorptive properties of the materials through which the light is passing. The thickness of the material is referred to as the pass length. Increasing or decreasing the thickness, or concentration of the absorptive material(s) directly results in the increasing or decreasing of the absorbance value of the material(s). Beer-Lamberts law can be defined as:

$$A = ebc$$

where A is the Optical Density (OD), e is the absorptivity value, b is the path length, and c is the concentration unit(s). The OD is the material's ability to absorb the light (radiation). The equation to convert absorbance to percent transmission (PLT) is A=2-log ₁₀% T.

Once the absorptive material(s) are selected, a sample can be made and assessed spectrophotometrically for transmission, OD vs wavelength (nm), and chromaticity. The sample can then be laser damage or irradiated for confirmation of design.

The lenses may be formed of a base material, such as acrylic, polycarbonate, biopolymers, and/or copolymers. In some embodiments, the base material comprises a ballistic-grade polymer selected to meet impact resistance requirements while maintaining optical clarity. In one embodiment, a OQ2720 7.5 melt flow Lexan is used. The base material(s) may be selected for their transmission, OD, and/or impact (ballistics) qualities.

As noted above, one factor in the protective features is the thickness of the lens. The thickness of the lens may contribute to the absorbance/transmission (via the pass through length), OD, and/or impact (ballistics) characteristics of the lens.

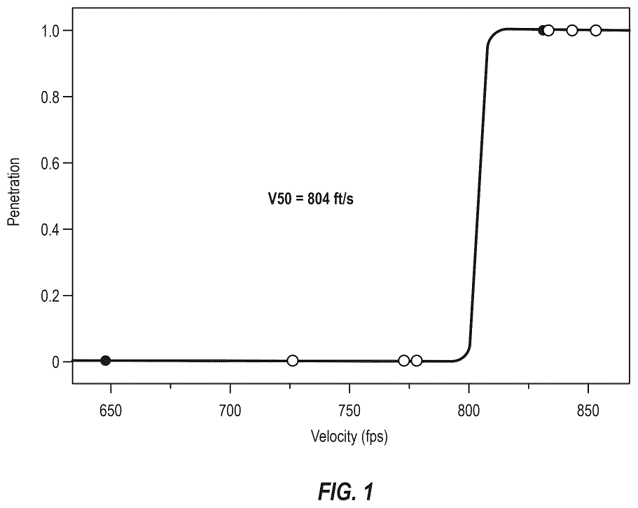

In some embodiments, the lens may have a thickness of at least about 1.20 mm, between about 1.2 mm and about 4 mm, or great that about 4 mm. In one embodiment, for instance, the lens may have a thickness of about 2.4 mm. When the base material is formed of a OQ2720 7.5 melt flow Lexan, a thickness of about 2.4 mm may provide an impact target of V50. As illustrated in FIG. 1, such a lens configuration may achieve a V50 impact rating exceeding 800 ft/s. A V50 impact target may provide impact or ballistic protection from objects traveling at greater than 800 ft/s. The embodiment of FIG. 1 achieved a V50 impact value of 804 ft/s.

The lens may also have a diameter of between about 30 mm and about 90 mm. In one embodiment, the lens may have a diameter of about 80 mm. The lens may also have a base curve of between about 0 to about 12. In one embodiment, the base curve is about 6.

The transmission and/or OD may be adjusted by adding one or more absorbing dyes to the base material(s). The one or more absorbing dyes may include dyes selected to attenuate radiation in ultraviolet, visible, and/or infrared wavelength ranges, including laser wavelengths. The processing method of putting the absorbing dye into the base material(s) may include compounding or blending. Compounding may include mixing of a base material(s) with the absorbing dye(s) in a molten state, which can them be formed (e.g., injection molded) into a lens blank. Blending may include mixing or tumbling the absorbing dye(s) with the base material(s) to get a uniform cohesive mix of pellet. Either of these processes can be used for various base material(s), such as polycarbonate or acrylic.

The base material(s) and the absorbing dye(s) may be selected to provide the various desired characteristics of the protective lenses. Reviewing the absorbing dye(s) compatibility on a molecular level or testing combinations soluble in ketones rolled on a rod as an ink and smeared on a film can assist in selection of the proper absorbing dye(s). A spectrophotometer or colorimeter may be used to measure the optical characteristics of the lenses. Beer-Lamberts law may be used to adjust the ratio of absorber dye(s) with the thickness of the lenses.

In one embodiment, a lens may be formed with a base material formed of a clear polycarbonate low melt flow resin. One or more absorbing and color correcting dye(s) may be added to the base material to help achieve the various desired protective and color optical properties. For instance, the dye(s) may include one or more of the following:
lambda max 1054 nm-laser dye 1 in base material
lambda max 814 nm-laser dye 2 in base material
lambda max 1090 nm-laser dye 3 in base material
lambda max 498 nm-dye 4 in base material
lambda max 408 nm-dye 5 in base material
UV absorber
Sunglass dye on film
lambda max 900 nm-dye 7 on film

Each of the foregoing dyes is provided as a non-limiting example, and other dyes having similar or different absorption characteristics may additionally or alternatively be used.

It will be appreciated that the number of dyes and the specific dyes used may vary from one embodiment to another. For instance, the dyes may be selected based on the specific optical properties desired for the protective lenses. In some embodiments, it may be desirable to select dye(s) that have narrow full width half maximum values.

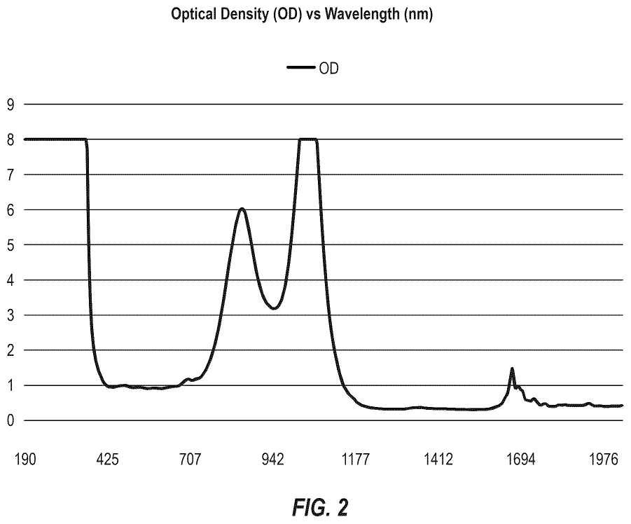

As noted above, the base material(s) and the dye(s) may be selected to provide the lenses with desired laser protection characteristics. In some embodiments, the level of laser protection may be determined by the optical density (OD) of the lens. To provide sufficient laser protection, it may be desired that the lens have an optical density of 4+ at 180-300 nm, 7+ at 1064 nm, and 4+ at 820-870 nm. An example optical density profile corresponding to such attenuation characteristics is illustrated in FIG. 2. With the above-noted example embodiment, and as shown in the FIG. 2, the lens achieved optical densities of 5+ at 180-300 nm, 8+ at 1064 nm, and 5+ at 820-870 nm.

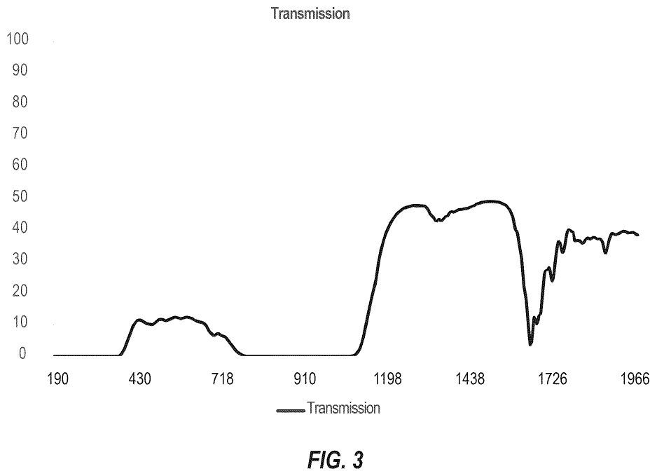

The base material(s) and the dye(s) may also be selected to provide the lenses with desired absorbance/transmission characteristics. For instance, it may be desirable to have percentage of light transmission or photopic luminous transmission values of between 18%-40% or greater. An example transmission profile corresponding to such characteristics is illustrated in FIG. 3. The above-noted example embodiment achieved a PLT value of about 26%, as shown in the following Table 1 and FIG. 3.

TABLE 1

| | |
|---|---|
| Illuminant | 1.6 |
| A | 26.62% |
| C | 26.65% |
| Unity photopic | 26.66% |
| Unity scotopic | 26.23% |
| D65 | 26.66% |
| E | 19.49 |
| UV Transmission Near | 19.49 |
| UV Transmission Far | 0.0064% |
| Haze | 0.0019% |
| Neutrality | — |
| Chromaticity x | 0.31 |
| Chromaticity y | 0.32 |
| Red Signal Transmittance | 0.94 |

At least some of the dye(s) may be selected to balance, offset, or counteract the color distortions resulting from some of the other dye(s) included in the lens. Such dyes are referred to herein as color-correcting dyes and are selected to reduce non-uniform attenuation across the visible spectrum without materially degrading protective performance. For instance, certain absorbing dye(s) may be selected to provide the lens with laser, UV, and/or VIS protection and/or transmission characteristics. These dye(s), however, may distort the colors transmitted through the lens. Accordingly, one or more color-correcting dye(s) may be added to the lens to balance, offset, or counter the color distortion resulting from the absorbing dye(s) without impacting the protective characteristics of the lens.

In some embodiments, individual dyes may be chromatic when considered in isolation; however, when combined, the dyes cooperate to produce a lens having a substantially neutral or gray spectral appearance. The gray appearance results from balancing spectral attenuation across the visible wavelength range. Each of the dyes may be configured to balance, offset, or counteract one or more the color distorting characteristics resulting from some of the other dye(s).

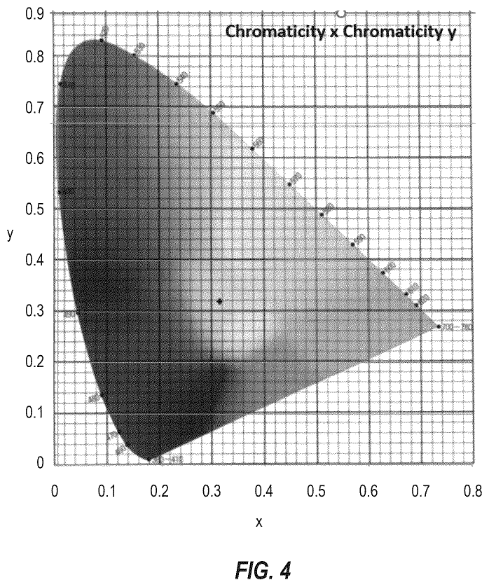

Balancing, offsetting, or counteracting the color distortions resulting from some of the other dye(s) may be referred to as neutrality. Neutrality may be evaluated using chromaticity measurements, such as those illustrated in FIG. 4, which depict deviation from a neutral reference point. Some current standards call for a neutrality target of between 12% and 18%. Such standards would mean that the color distortions are reduced so that the resulting distortion is only 12% to 18% distorted from the true colors. There is a desire to achieve neutrality values of between 4% and 5%. Thus, the lenses of the present disclosure may have neutrality values of equal to or less than 12%, 10%, 5%, 2.5%, 1%, 0.5%, 0.25%, or 0.22%.

The above-noted example embodiment, as shown in the FIG. 4, achieves a neutrality value of about 0.22%. Such a small color distortion is essentially imperceptible to the human eye. Thus, the above-noted example lens provides the laser, transmission, and impact protection characteristics with essentially no color distortion that is common in other protective lenses.

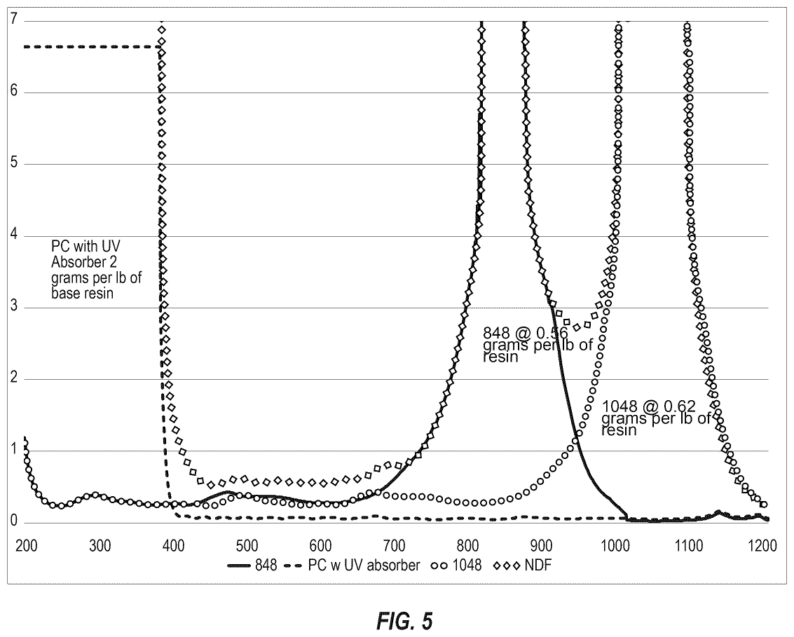

In some embodiments, a representative spectral profile, such as those illustrated in FIGS. 2-4, may be achieved using an example dye formulation. FIG. 5 illustrates one example formulation corresponding to a representative finished spectral curve. In this example, a polycarbonate base resin includes a UV absorber and a plurality of absorbing dyes provided at selected loadings relative to the base resin. The formulation illustrated in FIG. 5 is provided as a non-limiting example of one combination of components that may be used to achieve the illustrated optical density, transmission, and chromaticity characteristics.

As illustrated in FIG. 5, the example formulation includes a polycarbonate base resin containing a UV absorber at a loading of approximately 2 grams per pound of base resin. The formulation further includes a first absorbing dye having an absorption peak at or near 848 nm at a loading of approximately 0.56 grams per pound of base resin, and a second absorbing dye having an absorption peak at or near 1048 nm at a loading of approximately 0.62 grams per pound of base resin. The example formulation corresponds to the representative spectral response illustrated in FIGS. 2-4.

The color correcting dye(s) may be selected by determining the color distortion created by the absorbing dye(s). The color correcting dye(s) may be selected from the opposite side of the color wheel to neutralize the color created by the absorbing dye(s). Complementary colors when combined or mixed, cancel each other out and lose chroma. The addition of a color correcting dye may help balance the distortion caused by the absorbing dye(s). However, a color correcting dye may itself introduce some color distortion. Therefore, one or more additional color correcting dyes may be added to further correct the color distortion of the lens (the from absorbing dye(s) and other color correcting dye(s)).

In some embodiments, the protective eyewear lens is configured as a sunglass lens. Such embodiments may include reduced photopic luminous transmission values while maintaining low color distortion and protective optical density characteristics. Example sunglass embodiments may comply with one or more applicable sunglass standards, including ANSI Z87 and ISO 12311.

In some embodiments, the spectral response of the lens may be selectively tuned to enhance recognition of one or more colors while maintaining an overall low neutrality value. Such selective color recognition may be achieved without substantially increasing overall color distortion and may be application dependent.

Lenses according to the present disclosure may meet the standards provided for in ANSI Z136.1, 2,.3.,4,.5, 7,8,9, ANSI Z87, ANSI Z80, ANSI Z81, ISO12311:2023 (sunglasses), and/or MIL-PRF-32432A.

In one example embodiment, a protective eyewear lens is configured to provide laser protection across multiple wavelength bands while maintaining exceptionally low color distortion and ballistic impact resistance. The lens comprises a ballistic-grade polymer base material, one or more absorbing dyes selected to attenuate ultraviolet and infrared radiation, and one or more color-correcting dyes configured to reduce non-uniform attenuation across the visible spectrum.

In this example embodiment, the lens is configured to attenuate ultraviolet radiation in a wavelength range from about 180 nm to about 300 nm, infrared radiation at or near about 1064 nm, and infrared radiation in a wavelength range from about 820 nm to about 870 nm. In an example implementation, the lens is configured with optical density values exceeding OD4 in the ultraviolet range, exceeding OD7 at about 1064 nm, and exceeding OD4 in the 820-870 nm range, as illustrated by the optical density profile shown in FIG. 2.

The lens is further configured with a photopic luminous transmission value within a range from about 18% to about 40%. In an example implementation, the lens may exhibit a photopic luminous transmission value of approximately 26%, as illustrated by the transmission profile shown in FIG. 3.

In this example embodiment, the combination of absorbing dyes and color-correcting dyes may produce a substantially neutral spectral response across the visible spectrum. In an example implementation, the lens may exhibit a neutrality value significantly below 5%, including as low as approximately 0.22%, as illustrated by the chromaticity plot shown in FIG. 4.

The lens may further exhibit ballistic impact resistance suitable for protective eyewear applications. In this example embodiment, a lens having a thickness of approximately 2.4 mm may achieve a V50 impact rating greater than 800 ft/s, as illustrated in FIG. 1.

This example embodiment demonstrates that high levels of laser and ultraviolet protection and ballistic performance may be achieved in a polymeric protective eyewear lens while maintaining exceptionally low color distortion.

In another example embodiment, a protective eyewear lens is configured as a sunglass lens while maintaining laser protection and low color distortion. The lens may comprise a polymeric base material, one or more absorbing dyes selected to attenuate ultraviolet and infrared radiation, and one or more color-correcting dyes configured to maintain a substantially neutral spectral appearance.

In this example embodiment, the lens is configured to provide attenuation of ultraviolet radiation in a wavelength range from about 180 nm to about 300 nm, infrared radiation at or near about 1064 nm, and infrared radiation in a wavelength range from about 820 nm to about 870 nm. Optical density characteristics of the lens may be similar to those described with respect to the previous example embodiment and illustrated in FIG. 2.

The lens may be further configured to have a reduced photopic luminous transmission value suitable for sunglass use. In this example embodiment, the lens may have a photopic luminous transmission value of less than about 20%. In an example implementation, the lens may exhibit a photopic luminous transmission value between about 12% and about 16%, and in some implementations approximately 14.5%.

Despite the reduced transmission associated with sunglass configurations, the lens may maintain low color distortion. In this example embodiment, chromaticity measurements may include a neutrality value below about 5%, and in some implementation approximately 1.1%.

In some implementations of this example embodiment, the lens may be configured to comply with one or more applicable sunglass standards, including ANSI Z87 and ISO 12311, while simultaneously providing laser protection and maintaining low color distortion.

This example embodiment demonstrates that sunglass-level attenuation may be achieved in a protective eyewear lens while preserving laser protection and substantially neutral color perception.

Following are some further example embodiments of the invention. These are presented only by way of example and are not intended to limit the scope of the invention in any way. Further, any example embodiment can be combined with one or more of the example embodiments.

Embodiment 1. A protective eyewear lens, comprising: one or more base materials; one or more absorbing dyes; and one or more color-correcting dyes, wherein the lens is configured to: attenuate electromagnetic radiation in at least one ultraviolet wavelength range and at least one infrared wavelength range; and exhibit a neutrality value of less than 12%, wherein the color-correcting dyes reduce non-uniform attenuation across a visible spectrum without materially degrading protective performance of the lens.

Embodiment 2. The protective eyewear lens of embodiment 1, wherein the lens has an optical density of at least OD4 in a wavelength range from about 180 nm to about 300 nm.

Embodiment 3. The protective eyewear lens of embodiment 1, wherein the lens has an optical density of at least OD7 at about 1064 nm.

Embodiment 4. The protective eyewear lens of embodiment 1, wherein the lens has an optical density of at least OD4 in a wavelength range from about 820 nm to about 870 nm.

Embodiment 5. The protective eyewear lens of embodiment 1, wherein the lens has a photopic luminous transmission value between about 18% and about 40%.

Embodiment 6. The protective eyewear lens of embodiment 1, wherein the neutrality value is less than 5%.

Embodiment 7. The protective eyewear lens of embodiment 1, wherein the neutrality value is less than 1%.

Embodiment 8. A protective eyewear lens configured as a sunglass lens, comprising: a ballistic-grade polymer base material; one or more absorbing dyes configured to attenuate ultraviolet and infrared radiation; and one or more color-correcting dyes, wherein the lens: has a photopic luminous transmission value of less than 20%; attenuates at least one laser wavelength; and exhibits a neutrality value of less than 12%.

Embodiment 9. The protective eyewear lens of embodiment 8, wherein the neutrality value is less than 5%.

Embodiment 10. The protective eyewear lens of embodiment 8, wherein the photopic luminous transmission value is between about 12% and about 16%.

Embodiment 11. The protective eyewear lens of embodiment 8, wherein the lens complies with at least one of ANSI Z87 or ISO 12311 sunglass standards.

Embodiment 12. The protective eyewear lens of embodiment 8, wherein the base material comprises polycarbonate.

Embodiment 13. The protective eyewear lens of embodiment 8, wherein the lens is configured to provide impact resistance corresponding to a V50 rating greater than 800 ft/s.

Embodiment 14. A protective eyewear lens, comprising: one or more base materials; one or more absorbing dyes; and one or more color-correcting dyes, wherein the lens has: optical density values of at least OD4 in a wavelength range from about 180 nm to about 300 nm, at least OD7 at about 1064 nm, and at least OD4 in a wavelength range from about 820 nm to about 870 nm; a photopic luminous transmission value between about 18% and about 40%; an impact rating corresponding to a V50 value greater than 800 ft/s; and a neutrality value of less than 12%.

Embodiment 15. The protective eyewear lens of embodiment 14, wherein the neutrality value is less than 5%.

Embodiment 16. The protective eyewear lens of embodiment 14, wherein the neutrality value is less than 1%.

Embodiment 17. The protective eyewear lens of embodiment 14, wherein the one or more base materials comprise polycarbonate.

Embodiment 18. The protective eyewear lens of embodiment 14, wherein the one or more absorbing dyes include at least one dye having an absorption peak at or near 1054 nm, 814 nm, or 1090 nm.

Embodiment 19. The protective eyewear lens of embodiment 14, wherein the one or more absorbing dyes further include at least one dye having an absorption peak within a visible wavelength range.

Embodiment 20. The protective eyewear lens of embodiment 14, wherein the lens has a thickness between about 1.2 mm and about 4 mm.

Embodiment 21. A protective lens, comprising: one or more base materials; one or more absorbing dyes; and one or more color correcting dyes, wherein the lens has the following properties: optical density values of: OD4+@180-300 nm, OD7+@ 1064 nm, and OD4+820-870 nm; a PLT value of 18% to 40%; an impact rating of V50 greater than 800 ft/s; and a neutrality value of less than 12%.

Embodiment 22. The protective lens of embodiment 21, wherein the optical density values are OD5+@180-300 nm, OD8+@ 1064 nm, and OD5+820-870 nm.

Embodiment 23. The protective lens of embodiment 21, wherein the PLT value is about 26%.

Embodiment 24. The protective lens of embodiment 21, wherein the neutrality value is less than about 10%.

Embodiment 25. The protective lens of embodiment 21, wherein the neutrality value is less than about 5%.

Embodiment 26. The protective lens of embodiment 21, wherein the neutrality value is less than about 2.5%.

Embodiment 27. The protective lens of embodiment 21, wherein the neutrality value is less than about 1%.

Embodiment 28. The protective lens of embodiment 21, wherein the neutrality value is less than about 0.5%.

Embodiment 29. The protective lens of embodiment 21, wherein the neutrality value is less than about 0.25%.

Embodiment 30. The protective lens of embodiment 21, wherein the neutrality value is about 0.22%.

Embodiment 31. The protective lens of embodiment 21, wherein the base material(s) and the absorbing dye(s) cooperate to provide the optical density values.

Embodiment 32. The protective lens of embodiment 21, wherein the color correcting dye(s) offset the color distortions resulting from the absorbing dye(s) to provide the neutrality value.

Embodiment 33. The protective lens of embodiment 21, wherein the impact rating of V50 is 804 ft/s.

Embodiment 34. The protective lens of embodiment 21, wherein the lens meets the standards of ANSIZ136.1, 2,.3.,4, 5,.7,.8,9, ANSI Z80, ANSI Z81, ISO12311:2023 (sunglasses), and MIL-PRF-32432A.

Embodiment 35. The protective lens of embodiment 21, wherein the lens has a thickness of 1.2 mm to 4 mm.

Embodiment 36. The protective lens of embodiment 21, wherein the lens has a thickness of about 2.4 mm.

Embodiment 37. The protective lens of embodiment 21, wherein the base material(s) comprise polycarbonate, acrylic, biopolymers, and/or copolymers.

Embodiment 38. The protective lens of embodiment 21, wherein the base material(s) comprise a OQ2720 7.5 melt flow Lexan.

Embodiment 39. The protective lens of embodiment 21, wherein each of the color correcting dye(s) comprises a gray dye.

Embodiment 40. The protective lens of embodiment 39, wherein each of the color correcting dye(s) comprises a different gray dye.

Embodiment 41. A protective lens, comprising: one or more base materials; one or more absorbing dyes; and one or more color correcting dyes, wherein the lens has a neutrality value of less than 12% and one or more of the following properties: optical density values of: OD4+@180-300 nm, OD7+@ 1064 nm, and OD4+820-870 nm; a PLT value of 18% to 40%; and/or an impact rating of V50 greater than 800 ft/s.

The terms “approximately,” “about,” “near,” and “substantially” as used herein represent an amount close to the stated amount that still performs a desired function or achieves a desired result. For example, the terms “approximately,” “about,” and “substantially” may refer to an amount that is within less than 10% of, within less than 5% of, within less than 1% of, within less than 0.1% of, and within less than 0.01% of a stated amount.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A protective eyewear lens, comprising:
one or more base materials;
one or more absorbing dyes; and
one or more color-correcting dyes,
wherein the lens is configured to:
attenuate electromagnetic radiation in at least one ultraviolet wavelength range and at least one infrared wavelength range; and
exhibit a neutrality value of less than 12%,
wherein the color-correcting dyes reduce non-uniform attenuation across a visible spectrum without materially degrading protective performance of the lens.

2. The protective eyewear lens of claim 1, wherein the lens has an optical density of at least OD4 in a wavelength range from about 180 nm to about 300 nm.

3. The protective eyewear lens of claim 1, wherein the lens has an optical density of at least OD7 at about 1064 nm.

4. The protective eyewear lens of claim 1, wherein the lens has an optical density of at least OD4 in a wavelength range from about 820 nm to about 870 nm.

5. The protective eyewear lens of claim 1, wherein the lens has a photopic luminous transmission value between about 18% and about 40%.

6. The protective eyewear lens of claim 1, wherein the neutrality value is less than 5%.

7. The protective eyewear lens of claim 1, wherein the neutrality value is less than 1%.

8. A protective eyewear lens configured as a sunglass lens, comprising:
a ballistic-grade polymer base material;
one or more absorbing dyes configured to attenuate ultraviolet and infrared radiation; and
one or more color-correcting dyes,
wherein the lens:
has a photopic luminous transmission value of less than 20%;
attenuates at least one laser wavelength; and
exhibits a neutrality value of less than 12%.

9. The protective eyewear lens of claim 8, wherein the neutrality value is less than 5%.

10. The protective eyewear lens of claim 8, wherein the photopic luminous transmission value is between about 12% and about 16%.

11. The protective eyewear lens of claim 8, wherein the lens complies with at least one of ANSI Z87 or ISO 12311 sunglass standards.

12. The protective eyewear lens of claim 8, wherein the base material comprises polycarbonate.

13. The protective eyewear lens of claim 8, wherein the lens is configured to provide impact resistance corresponding to a V50 rating greater than 800 ft/s.

14. A protective eyewear lens, comprising:
one or more base materials;
one or more absorbing dyes; and
one or more color-correcting dyes,
wherein the lens has:
optical density values of at least OD4 in a wavelength range from about 180 nm to about 300 nm, at least OD7 at about 1064 nm, and at least OD4 in a wavelength range from about 820 nm to about 870 nm;
a photopic luminous transmission value between about 18% and about 40%;
an impact rating corresponding to a V50 value greater than 800 ft/s; and
a neutrality value of less than 12%.

15. The protective eyewear lens of claim 14, wherein the neutrality value is less than 5%.

16. The protective eyewear lens of claim 14, wherein the neutrality value is less than 1%.

17. The protective eyewear lens of claim 14, wherein the one or more base materials comprise polycarbonate.

18. The protective eyewear lens of claim 14, wherein the one or more absorbing dyes include at least one dye having an absorption peak at or near 1054 nm, 814 nm, or 1090 nm.

19. The protective eyewear lens of claim 14, wherein the one or more absorbing dyes further include at least one dye having an absorption peak within a visible wavelength range.

20. The protective eyewear lens of claim 14, wherein the lens has a thickness between about 1.2 mm and about 4 mm.
